(19) United States
(12) Patent Application Publication
(10) Pub. No.: US 2002/0053505 A1
(43) Pub. Date: May 9, 2002

(54) Horizontal distillation apparatus and method

(76) Inventor: Norman L. Arrison, Edmonton, CA (US)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 09/682,778

(22) Filed: Oct. 18, 2001

Related U.S. Application Data
(63) Continuation of application No. PCT/CA00/00449, filed on Apr. 20, 2000.
(60) Provisional application No. 60/130,641, filed on Apr. 23, 1999.

(51) Int. Cl. B01D 3/42; B01D 5/00

(52) U.S. Cl. 203/2; 203/87; 203/100; 202/160; 202/173; 202/185.3; 202/186

(57) ABSTRACT

A horizontal distillation system includes a series of collection tanks interconnected by condensing tubes. Each condensing tube has an ascending portion, a transition portion and a descending portion. Liquid which condenses from a multi-component vapor feed falls into the collection tanks. Each tank may include a heating element to heat or reboil the liquid collected in each tank. The last tank may include a cooling element to condense any remaining vapors.

This application is a continuation of PCT International Application No. PCT/CA00/00449 filed on Apr. 20, 2000 which claims the priority benefit of U.S. Provisional Application No. 60/130,641 filed on Apr. 23, 1999.

### BACKGROUND OF INVENTION

The present invention relates to a distillation system. More particularly, it relates to a horizontal distillation system.

Distillation is a process of physically separating a mixture of two or more components having different boiling points, by preferentially boiling the more volatile components out of the mixture. When a liquid mixture of two or more volatile components is heated, the vapour that comes off will have a higher concentration of the more volatile components than the liquid mixture from which it has evolved. Conversely, if a vapour mixture is cooled, the less volatile components in that vapour will condense in a greater proportion than the more volatile components. Distillation is a well-known unit operation which continues to be the primary method of separation in processing plants, in spite of its inherently low thermodynamic efficiency.

Conventional distillation columns are used to separate components in a multi-component vapour. The vapour is fed up a column which is cooled primarily at the top by a condenser. The least volatile compounds in the vapour will condense out on the trays or packing of the column obeying Raoult's law, Dalton's law and the preservation of mass balance. The more volatile compounds will condense in the column at a higher level as the vapour rises in the column. The distillation process involves both stripping and rectifying. As the liquid condenses in the column, it will flow downwards and as it does, it will contact and rectify or cause to condense the less volatile compounds in the rising vapour. At the same time, the rising vapour will preferentially strip the more volatile compounds from the downward flowing liquid.

Therefore, it would improve the efficiency of the operation to cool the rectifying section and heat the stripping section. This is accomplished in the prior art by placing heat exchangers within the distillation column. The use of heat exchangers is however exorbitantly expensive. One alternative found in U.S. Pat. No. 4,025,398 (Haselden) is to provide separate stripping and rectifying columns. This solution also utilizes heat exchangers between the two separate columns. Again, the problem is that of expense and complexity.

The thermodynamic efficiency of a distillation tower may be enhanced by providing intercondensors and/or interreboilers along the distillation tower. The problem is again that of expense and complexity of design.

The prior art distillation columns are used in such industrial processes as refining crude oil and chemical processes to produce various useful end products. These columns are usually elaborate, reach large heights, require large capital expenditures to construct and large ongoing expenses of operation and maintenance. Often, the columns must be different diameters in different sections of the column to avoid flooding the column or column dry-out, both of which are recognized difficulties in the industry. The changes in diameter exacerbate the expense and complexity of prior art columns.

Therefore, there is a need in the art for a relatively efficient distillation system which is inexpensive and conveniently simple to design and build.

### SUMMARY OF INVENTION

In general terms, this invention is directed to a novel distillation system which comprises a series of collection tanks wherein adjacent collection tanks are connected by at least one condensation tube which has a rising vertical component, a descending vertical component and a transition component. Each tank may have an integral heat or coolant source and one or more outlets to remove condensed liquids from each tank. The condensation tubes may be cooled by simply exposing them to the ambient atmosphere or by flowing cool air or water or other cooling fluids past the condensation tubes. In addition, the condensation tubes may be finned to increase the cooling effect. Conversely, a condensation tube, or a portion of a condensation tube, may be insulated to reduce condensation if that is desired.

The condensation tubes may be an inverted “U”shape or an inverted “V”shape or other shapes that have any ascending section, a transition section and a descending section. Therefore, the tubes have a vertical component and a horizontal component which allows the tubes to interconnect adjacent, horizontally level collection tanks.

Therefore, in one aspect of the invention, the invention comprises a distillation system for separating the components of a multi-component vapour feed, said system comprising:(a) a plurality of collection tanks connected in series, including a first tank and a last tank;(b) wherein each tank comprises a vapour inlet, a vapour outlet and a liquid outlet; and (c) wherein adjacent tanks are connected by at least one condensation tube connecting the vapour outlet of the preceding tank to the vapour inlet of the next tank, which condensation tube comprises an ascending section, a transition section and a descending section; wherein liquid which condenses in the ascending section collects in the tank from which it ascends and liquid which condenses in the descending section collects in the next tank.

In another aspect of the invention, the invention is a method of separating two or more components in a multi-component fluid mixture, said method comprising the steps of;

(a) providing a plurality of collection tanks connected in series, including a first tank and a last tank; wherein each tank comprises a vapour inlet, a vapour outlet and a liquid outlet; and wherein adjacent tanks are connected by at least one condensation tube connecting the vapour outlet of the preceding tank to the vapour inlet of the next tank, which condensation tube comprises an ascending section, a transition section and a descending section;

(b) heating or boiling the mixture and passing the mixture into the first tank, through the at least one condensation tube and into the next tank; and

collecting the liquid which condenses and collects in the first tank and collecting the liquid which condenses and collects into the next tank.

### BRIEF DESCRIPTION OF DRAWINGS

The invention will now be described by way of an exemplary embodiment with reference to the accompanying simplified, diagrammatic, not-to-scale drawings. In the drawings: FIG. 1 is a schematic representation of an embodiment of the present invention comprising two collection tanks connected by a plurality of “U”shaped condensation tubes.

FIG. 2 is a schematic representation of five collection tanks connected by “U”shaped condensation tubes.

FIG. 3 is a schematic representation of two parallel series of tanks which merge into a single series.

FIG. 4 is a schematic representation of an alternative embodiment of the condensation tubes wherein the tubes are rectangular.

FIG. 5 is a schematic representation of an alternative embodiment of the condensation tubes wherein the condensation tubes are shaped as inverted “V”s.

FIG. 6 is a schematic representation of an alternative embodiment of the invention where the condensation tubes are enclosed within cooling compartments and cooled by a counter current air flow.

FIG. 7 is a schematic representation of yet another alternative embodiment showing a variation of the configuration of the condensation tubes and the cooling compartments.

FIG. 8 is a schematic representation of an alternative embodiment of a distillation system according to the present invention.

FIG. 9 is a schematic representation of an alternative embodiment of a distillation system showing an alternative configuration of the condensation tubes.

### DETAILED DESCRIPTION

The present invention provides for a distillation system (10) for separating components in a liquid or gaseous feedstock comprising a mixture of those components. The present invention may be adapted for separation by distillation processes involving a variety of different organic or inorganic compounds. All terms used herein and not specifically defined herein have their common art-recognized meanings.

The principles of a distillation system and the theoretical design of a distillation system have been thoroughly studied and many such principles are applicable to the within invention. A person skilled in the art may consult textbooks such as “Distillation Design” by Henry Z. Kister, 1992, McGraw-Hill, New York, the entire contents of which are incorporated herein by reference.

Embodiments of the apparatus (10) shown schematically in the Figures comprise a series of collection tanks (12) interconnected by condensation tubes (14) which extend upwards from a tank (12), horizontally towards the next collection tank (12) and downwards to couple with the vapour inlet of the next tank (12). Vapour (V) which may be produced by boiling or heating a liquid feedstock passes through the series of condensation tubes (14). Liquids which condense within the condensation tubes (14) collect in the tanks by gravity.

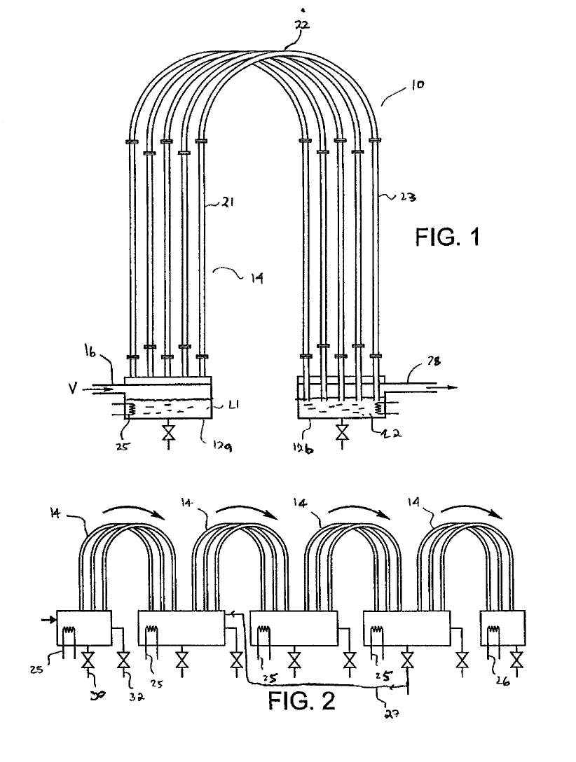

FIGS. 1 and 2 demonstrate a basic configuration of the invention. The first tank (12a) receives a multi-component gas vapour feedstock (V) through an inlet (16). The feedstock (V) may have been produced by continuously heating or boiling a liquid feedstock comprising the components, the separation of which is desired. A portion of the inlet (16) preferably leads downward into the first tank (12a) where some of the least volatile compounds in the vapour (V) may condense and flow into the first tank (12a). The condensation tube (14) which rises from the first tank has an ascending section (21), a transition section (22) and a descending section (23). There may be more than one condensation tube (14) connecting between two collection tanks. Obviously, as the number of condensation tubes (14) increases, and as the diameter of the condensation tubes decreases, the surface area to volume ratio of the tubes (14) increases, thereby increasing the cooling of the vapour within the condensation tubes.

The degree of verticality of the condensation tube (14) is dictated only by the length of the tube required for a desired separation, the flow by gravity of condensed liquids into the collection tanks (12). The embodiments shown have vertical or near vertical ascending and descending sections. Other embodiments not shown may have less verticality.

As the vapour feedstock (V) passes through the inlet (16), the first tank (12a) and the ascending section (21) of the first condensation tube (20), the least volatile compounds will tend to condense on the walls of inlet, the tank and the ascending portion of the first condensation tube and flow down into the first tank (12a). As will be appreciated by one skilled in the art, both rectifying and stripping will occur in the ascending portion (21) as vapour rises and condensed liquid falls through the ascending portion (21). The first tank may preferably, but not necessarily, have a heating element (25) which heats or boils the liquid (L) which has condensed into the first tank (12a), creating more vapour (V) to pass through the system. The first tank (12a) may require a boiler (25) if some or all of the feedstock introduced into the first tank is liquid.

Vapour which condenses on the walls of the descending section (23) of the first condensation tube (20) and the ascending section (21) of the second condensation tube (20b) will flow into the second transfer tank (12b). The composition of the liquid in the second tank (L2) will be enriched in the more volatile compounds as compared to the liquid (L1) in the first tank (12a). The second tank (12b) may also have a temperature control element in the form of a heating element or cooling element (25). The temperature of the liquid (L2) in the second tank (12b) may be less than or equal to that of the liquid (L1) in the first tank (12a). As the series of condensation tubes (14) and collection tanks (12) is repeated, the liquids produced will be more and more concentrated with lower boiling compounds whereas the vapour will be more and more concentrated with higher boiling compounds.

The bottom portion (24) of the descending section of the condensation tube may terminate below the liquid level of the second tank (12b), as is shown in FIG. 1, in which case the passing vapour will bubble through the liquids (12) collected in the second tank. Alternatively, the descending portion may terminate well above liquid level, in which case, the vapour will simply pass through the second tank above the liquid that is collected there.

The number of collection tanks (12) may be varied as required. FIG. 2 shows one embodiment having five collection tanks (12) connected by condensation tubes (14). As may be appreciated by one skilled in the art, the degree of separation from tank to tank is dependent upon a number of different factors including the diameter, length and number of the condensation tubes; whether or not the condensation tubes are cooled; and the temperature of the liquid in each tank. Of course, the number of tanks may also be varied in order to obtain final products of greater purity. Each tank may have a temperature control element which may be a heating element or a cooling element. In a preferred embodiment, each tank except the final tank has a heating element. The final tank in the series may preferably, but not necessarily, include a cooling element (26) to condense all of the remaining vapour. Alternatively, or in addition, an outlet (28) for any remaining vapours may be provided.

Liquid may be recirculated in the system as is shown by the liquid transfer pipint (27) in FIG. 2.

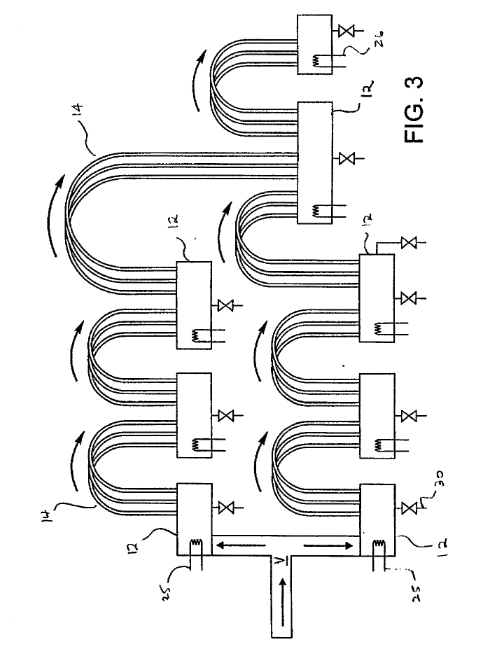

As shown in FIG. 3, the system may comprise two parallel series of tanks (12) and condensation tubes (14) which converge into one series. The example shown may therefore handle a large volume of vapour/liquids in the initial stages. It is the equivalent of a distillation tower which narrows in diameter in the upper stages. Conversely, a single series of tanks (12) may diverge into two parallel series of tanks (not shown) which is the equivalent of a distillation tower which widens in diameter in the upper stages.

The volume of each tank (12) need not be uniform within the series of tanks (12). The same effect as a converging or diverging series of tanks may be achieved by providing larger tanks earlier or later in the series.

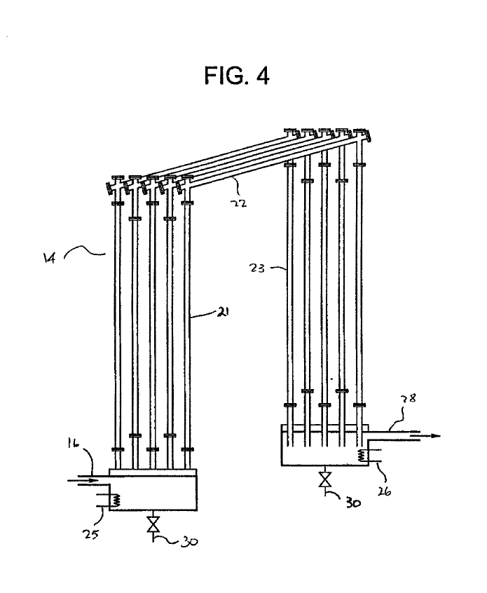

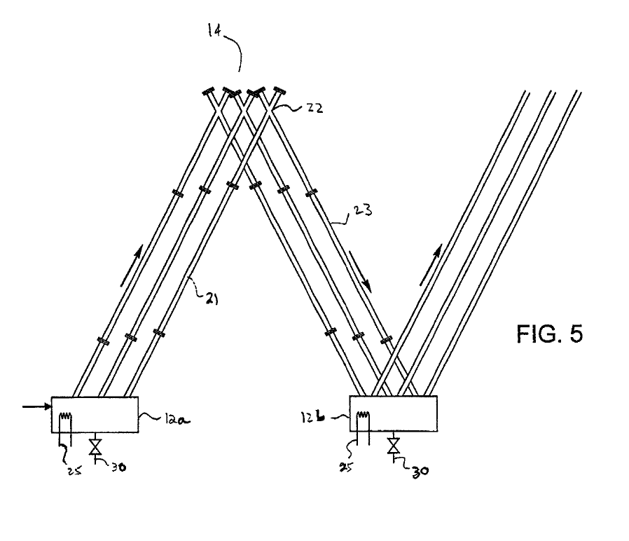

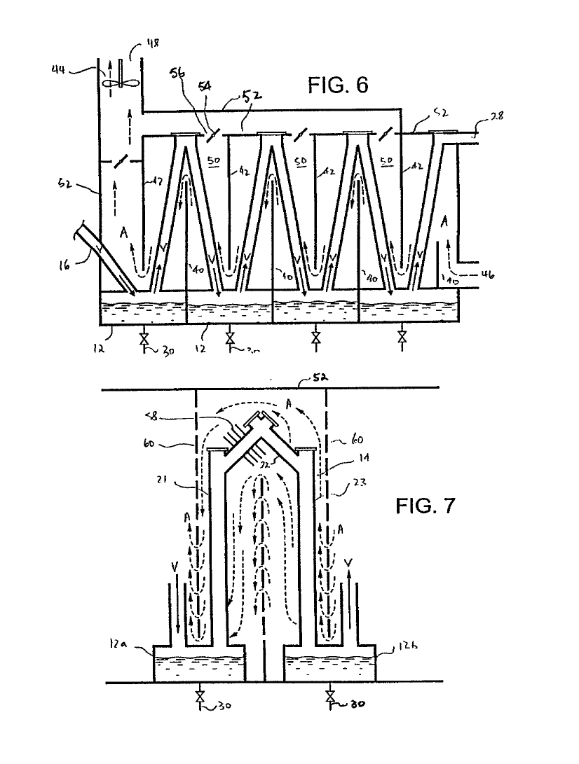

The condensation tubes (14) may be configured in a number of different alternative configurations as long the condensation tubes include an ascending section (21), a transition section (22) and a descending section (23). The shape, cross-sectional shape, length and diameter of the condensation tubes (14) may be varied by one skilled in the art to achieve a desired result. As will be appreciated by one skilled in the art, if the ascending and descending sections are equal in length, then the distillation system (10) may be substantially horizontal in configuration. In FIG. 1, “U” shaped condensation tubes are illustrated where the transition section (21) is curved. In FIG. 4, the condensation tubes (14) shown are rectangular in that the ascending and descending sections (21, 23) are vertical and are linked by a substantially horizontal transition section (22). In this embodiment, the transition section (22) may be sloped towards the preceding collection tank so that liquid which condenses within the transition section (21) flows towards the preceding tank (12a). Another embodiment is shown in FIGS. 5 and 6 which depict a “teepee” or an inverted “V”shaped condensation tube. In this embodiment of the condensation tube (14), the transition section (22) is very abrupt.

There is no requirement that the condensation tubes (14) be uniformly similar within the system. For example, the first two tanks may be connected by fewer, larger diameter tubes (14) to minimize condensation between those two tanks, while the second and third tanks in a series may be connected by many, smaller diameter tubes to maximize condensation between those two tanks.

In any embodiment, each tank (12) may have a liquid withdrawal tap (30) and may have a plurality of taps (32) at different levels of the tank to facilitate withdrawal of different immiscible liquids which may have condensed into that tank, as shown in FIG. 2 or 5.

The vapour (V) fed to the system by way of the inlet (16) to the first tank (12a) need not be pressurized. However, the vapour feedstock may be pressurized as the distillation system of the present invention may be designed to handle the same pressure ranges as conventional distillation columns. If not pressurized, the system (10) will draw vapour from tank to tank by the vacuum which is created by the increasing condensation of vapour in the system (10). Alternatively, a vacuum may be created at the outlet (28) of the last collection tank to draw the vapour (V) through the system.

The condensation tubes (14) may be cooled to assist the distillation process. In FIG. 6, an embodiment of the invention with countercurrent air cooling is shown. Each condensation tube (14) passes over an upwardly extending baffle (44) which diverts cooling air (A) along the path of the condensation tube (14). Downwardly extending baffles (42) are provided between adjacent condensation tubes (14) which accomplish the same function. Fans (44) at either the air inlet (46) or exhaust (48), or both the air inlet and exhaust, cause the cooling air (A) to move through the cooling chambers (50) created by the baffles. The cooling air may be at ambient temperature or may be chilled by a refrigeration process. In one embodiment, the ducting (52) within which the cooling air flows may insulated. The ducting (52) may be easily removed for access to the condensation tubes (14) and collection tanks (12) at the bottom of the tubes. Alternatively, access hatches (not shown) may be provided in the appropriate locations. Butterfly valves (54) for air control are shown at the top of each cooling chamber. Other means for opening and closing the air flow openings (56) such as plates or flaps which slidingly or hingedly engage the ducting may be appropriate. By opening or closing such valves, the air flow through a particular cooling chamber may be increased or decreased, thereby increasing or decreasing the degree of cooling of the condensation tubes (14) within that chamber.

A cooling fluid other than air, such as water or other liquids, may be used. The cooling fluid may be recirculated in a recirculating system (not shown). Of course, cooling means other than a circulating fluid may be used, such as the direct application of refrigerant coils (not shown).

An alternative condensation tube/cooling chamber configuration is shown in FIG. 7. In this embodiment, the condensation tubes (14) comprise a vertical ascending section (21), an inverted “V” shaped transition section (22) and a vertical descending section (23).

In this embodiment, cooling fins (58) or radiator plates may be provided on the first ascending stage of the transition section (21) which provides a more rapid temperature drop at that point in the condensation tube before the descending section. A larger temperature drop in that location may allow better separation of the components between the two tanks. Cooling air (A) is passed over the condensation tubes (14) through slotted baffles (60) which direct a substantial portion of the cooling air around the baffle (60) but allow a certain amount of air to bypass the baffle through the slots (62). The degree of cooling within any given cooling chamber may be varied by opening or closing the bypass slots (62) to increase or decrease the flow of coolant around the condensation tubes (14). The baffles (60) may be slotted or perforated in any manner to allow airflow through the baffle. Preferably, the baffle (60) will include cover plates or valves (not shown) for closing off the openings (62) when it is desired to restrict airflow through the baffles (60).

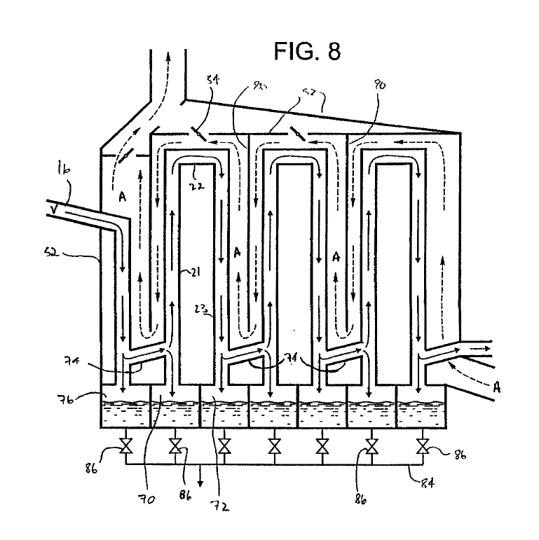

In FIG. 8, an alternative embodiment of the distillation system is shown. In this configuration, each collection tank is split into two compartments, the first (70) of which collects liquids condensed from the ascending portion (21) of a condensation tube (14) and the second (72) of which collects liquids condensed from the descending portion (23) of a condensation tube (14) as well as liquids condensed from a vapour bypass (74). An initial collection tank (76) is provided to collect condensation from the inlet (16). The vapour bypasses (74) are provided to divert the vapour directly to the next condensation tube (14) such that the vapour does not flow through the collection tanks (70, 72). Each vapour bypass (74) links the descending portion (23) of a condensation tube to the ascending portion (21) of the next condensation tube. The vapour bypasses (74) are substantially horizontal, however, they may be inclined slightly such that any liquid condensing in the vapour bypass flows towards the collection tank (72) connected to the descending portion (23) of the previous condensation tube. Again, cooling air (A) may be diverted around baffles (80) to provide a counter current flow to the vapour flow path. The baffles also may have bypass slots to control air flow volume and flow rate although they are not illustrated in FIG. 8. The specific embodiment illustrated in Figure has downwardly extending baffles between condensation tubes but does not have upwardly extending baffles (80) between the ascending and descending portions of a condensation tube. Again, the cooling chambers (50) are provided with butterfly valves (54) for controlling airflow through the system (10).

Also depicted in FIG. 8 is a liquid blending system (84) which connects the liquid outlets of each collection tank. This system includes a liquid outlet valve (86) for each collection tank and would allow the production of blending liquid products having relatively precise proportions of different liquid components which are separated by the distillation process.

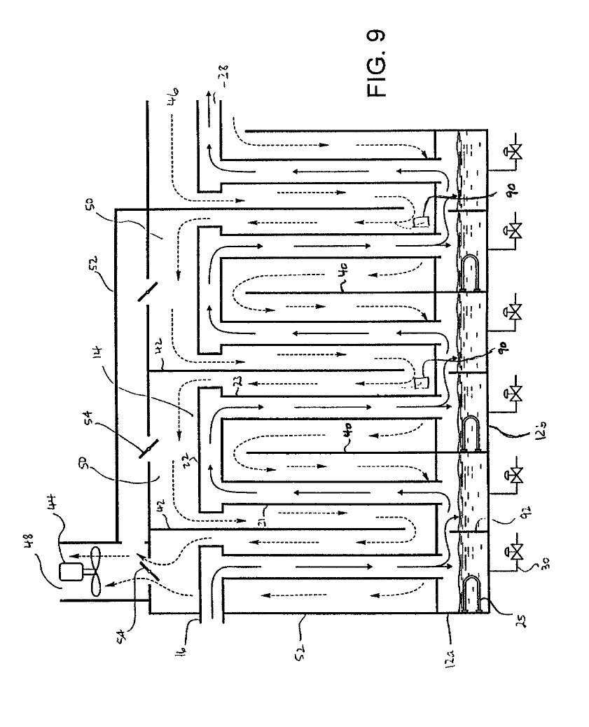

FIG. 9 is a schematic representation of a horizontal distillation system (10) showing flat topped condensation tubes (14) for easy cleaning and construction. The schematic also shows how air cooling can be varied on the system. The flat topped unit would also be easy to water cool should that be desired in hot climates. In this embodiment, port holes (90) are provided which may be used to let cool air into the cooling chambers directly. Also in FIG. 9, the collection tanks (12) shown are internally baffled (92) to separate the tank (12) into two liquid holding portions while still allowing vapour to pass through the tank (12) and into the next condensation tube (14).

In any embodiment, the tanks and tubes should be made of materials tailored to the fluids being distilled and condensed. This also applies to the initial boiler (not shown) which may be provided to feed vapour to the system (10).

As will be apparent to those skilled in the art, various modifications, adaptations and variations of the foregoing specific disclosure can be made without departing from the scope of the present invention.

1. A distillation system for separating the components of a multi-component vapour feed, said system comprising:
(a) a plurality of collection tanks connected in series, including a first tank and a last tank;
(b) wherein each tank comprises a vapour inlet, a vapour outlet and a liquid outlet; and
(c) wherein adjacent tanks are connected by at least one condensation tube connecting the vapour outlet of the preceding tank to the vapour inlet of the next tank, which condensation tube comprises an ascending section, a transition section and a descending section;
wherein liquid which condenses in the ascending section collects in the tank from which it ascends and liquid which condenses in the descending section collects in the next tank.

2. The distillation system of claim 1 wherein the first tank further comprises a temperature control element.

3. The distillation system of claim 2 wherein each tank includes a temperature control element.

4. The distillation system of one of claim 2 or 3 wherein the temperature control element in the first tank is a heating element.

5. The distillation system of claim 3 wherein the temperature control element in the last tank is a cooling element.

6. The distillation system of claim 1 wherein there are at least three tanks including a first tank, one or more intermediate tanks and a last tank.

7. The distillation system of claim 1 wherein the condensation tube is shaped substantially like an inverted “U”.

8. The distillation system of claim 1 wherein the condensation tube is shaped substantially like an inverted “V”.

9. The distillation system of one of claim 1, 7 or 8 wherein a plurality of condensation tubes are provided connecting adjacent distillation tanks.

10. The distillation system of claim 1 wherein the length of the condensation tube is adjustable.

11. The distillation system of claim 1 further comprising cooling means for cooling the condensation tube to promote condensation of the vapour within the condensation tube.

12. The distillation system of claim 11 wherein the cooling means comprises a fan for moving cooling fluid past the condensation tubes.

13. The distillation system of claim 12 wherein the cooling means further comprises ducting which encloses the condensation tubes and the fan is associated with the ducting to move cooling fluid through the ducting.

14. The distillation system of claim 13 wherein the ducting comprises at least one opening and a valve associated with the at least one opening which may be opened or closed to control coolant flow through the ducting.

15. The distillation system of claim 13 wherein the ducting comprises baffles between the descending portion of a condensation tube and the ascending portion of a subsequent condensation tube and between the ascending portion and descending portion of a condensation tube to direct cooling fluid along the path of the condensation tubes.

16. The distillation system of claim 14 wherein the baffles define a plurality of openings through which some cooling fluid may pass.

17. The distillation system of claim 15 wherein the baffles comprise means for opening or closing the openings to control coolant flow through the baffles.

18. The distillation system of claim 12 wherein the flow of cooling fluid is countercurrent to the flow of feedstock through the system.

19. The distillation system of claim 1 or 9 further comprising a vapour bypass which connects the descending portion of a condensation tube to the ascending portion of the next condensation tube, for allowing vapour to bypass the tank which is connected to said condensation tubes.

20. The distillation system of claim 19 wherein the tank which collects condensation from the descending section of a condensation tube is separate from the tank which collects condensation from the ascending section of the next condensation tube.

21. The distillation system of claim 1 or 9 further comprising liquid transfer means for transferring liquids from one tank into another tank.

22. The distillation system of claim 21 wherein the liquid transfer means transfers liquids from one tank to a previous tank.

23. The distillation system of claim 1 or 9 further comprising liquid blending means for combining liquids recovered from different tanks.

24. A method of separating two or more components in a multi-component fluid mixture, said method comprising the steps of;
(a) providing a plurality of collection tanks connected in series, including a first tank and a last tank; wherein each tank comprises a vapour inlet, a vapour outlet and a liquid outlet; and wherein adjacent tanks are connected by at least one substantially smooth bore condensation tube connecting the vapour outlet of the preceding tank to the vapour inlet of the next tank, which condensation tube comprises an ascending section, a transition section and a descending section;
(b) heating or boiling the mixture to produce a vapour and passing the [mixture] vapour into the first tank, through the at least one condensation tube and into the next tank; and
(c) collecting the liquid which condenses and collects in the first tank and collecting the liquid which condenses and collects into the next tank.

25. The method of claim 23 further comprising the step of heating or boiling the liquid in the first tank.

26. The method of claim 24 further comprising the step of heating or boiling the liquid in any subsequent tank.

27. The method of claim 23 further comprising the step of cooling some or all of the condensation tubes.

28. A distillation system for separating the components of a multi-component vapour feed, said system comprising:
(a) a plurality of collection tanks connected in series, including a first tank and a last tank;
(b) wherein each tank comprises a vapour inlet, a vapour outlet and a liquid outlet; and
(c) wherein adjacent tanks are connected by at least one condensation tube connecting the vapour outlet of the preceding tank to the vapour inlet of the next tank, which condensation tube comprises an ascending section, a transition section and a descending section; wherein liquid which condenses in the ascending section collects in the tank from which it ascends and liquid which condenses in the descending section collects in the next tank; and (d) a counter-current cooling system comprising ducting which encloses the condensation tubes, wherein said ducting follows the ascending and descending pattern of the condensation tubes(s) and a fan associated with the ducting for moving cooling fluid through the ducting.

29. The distillation system of claim 28 wherein there are a plurality of condensation tubes, each of which comprises smooth bore pipe and each of comprises cleaning access ports for cleaning an interior surface of the condensation tubes.

30. The distillation system of claim 28 or 29 wherein the length of the condensation tube or tubes is adjustable.

31. The distillation system of claim 28 wherein the ducting defines bypass openings permitting cooling fluid to bypass portions of the ducting as it passes through the ducting.

32. The distillation system of claim 28 further comprising liquid blending means for combining liquids recovered from different tanks.

33. The distillation system of claim 28 further comprising liquid transfer means for recycling liquids from one tank to a previous tank.
